(19) United States
(12) Patent Application Publication
(10) Pub. No.: US 2006/0039774 A1
(43) Pub. Date: Feb. 23, 2006

(54) Screw mechanism

(75) Inventor: Jian-Ming Lee, Taipei (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/207,867

(22) Filed: Aug. 22, 2005

(30) Foreign Application Priority Data
Aug. 23, 2004 (TW) 93125320

(51) Int. Cl. F16B 33/00

(52) U.S. Cl. 411/378

(57) ABSTRACT

A screw mechanism. The screw mechanism is extended along a central axis and seated in an object, comprising a head, a tail and a threaded shank formed therebetween, wherein the outer diameter of the threaded shank is less than the head. The tail comprises a flexible clasp deformed from a first position to a second position along the direction substantially perpendicular to the central axis when the screw mechanism is fastened into the object along a first direction. When the screw mechanism is moved out from the object opposite to the first direction, the flexible clasp abuts the object at the first position thereby preventing separation from the object.

### BACKGROUND

The present invention relates in general to a screw mechanism and in particular to a screw mechanism preventing separation thereof from an object.

Referring to FIG. 1, a traditional screw S driven through an object P primarily comprises a head 101 and a threaded shank 102. External threads 102′ with the same pitch are continuously formed on the shank 102, wherein the diameter of the head 101 is greater than the outer diameter of the threaded shank 102. As shown in FIG. 1, the screw S can be seated in an object P via the threaded shank 102 along the first direction A1. Conversely, the screw S can be removed from the object P by rotation along the second direction A2 opposite to the first direction A1. As the screw is easily removed from the object P, however, unexpected separation may occur.

### SUMMARY

Accordingly, an embodiment of the invention provides a screw mechanism. The screw mechanism is extended along a central axis and seated in an object, comprising a head, a tail and a threaded shank formed therebetween, wherein the outer diameter of the threaded shank is smaller than the head. The tail comprises a flexible clasp deformed from a first position to a second position along the direction substantially perpendicular to the central axis when the screw mechanism is seated in the object by rotation in a first direction. When the screw mechanism removed from the object by rotation opposite to the first direction, the flexible clasp abuts the object at the first position thereby preventing separation thereof from the object.

### BRIEF DESCRIPTION OF THE DRAWINGS

Embodiments of the present invention will become more fully understood from the detailed description given hereinbelow and the accompanying drawings, given by way of illustration only and thus not intended to be limitative of embodiments of the present invention.

FIG. 1 is a perspective diagram of a traditional screw seated in an object;

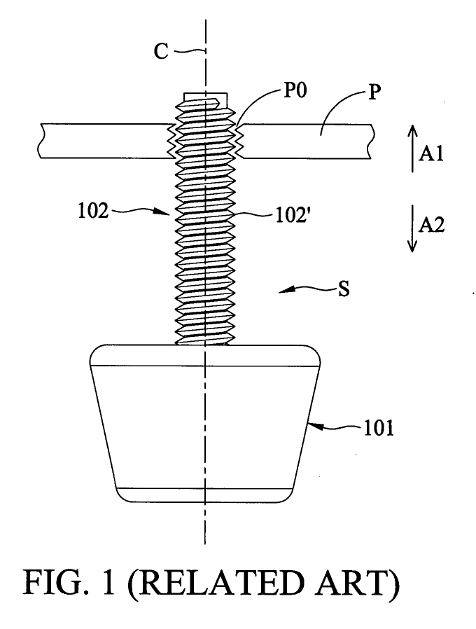

FIGS. 2a and 2b are perspective diagrams of the screw mechanism in accordance with an embodiment of the invention; and

FIG. 2c is a perspective diagram of the screw mechanism seated in an object in accordance with an embodiment of the invention.

### DETAILED DESCRIPTION

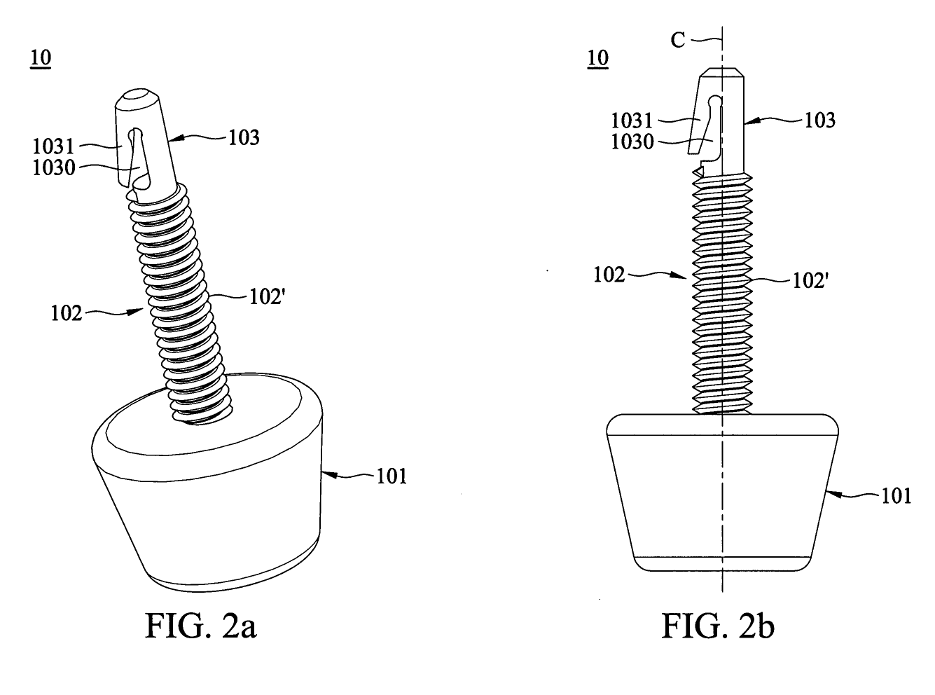

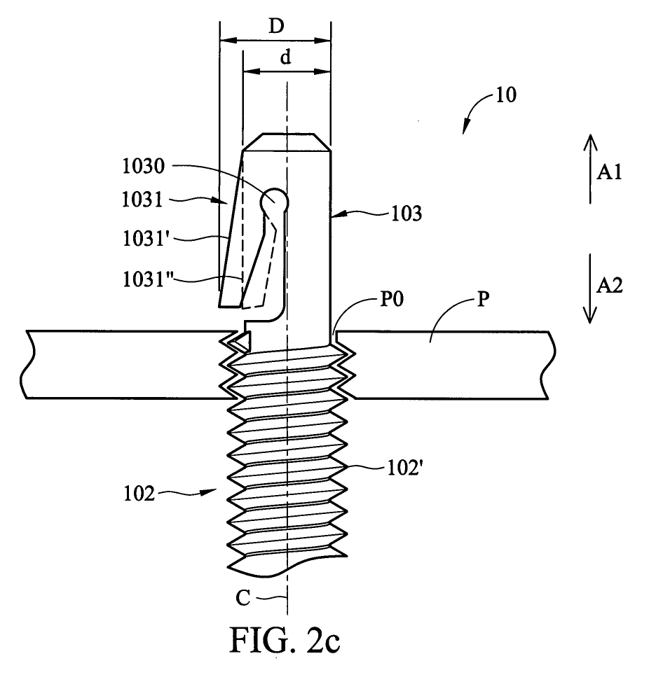

Referring to FIGS. 2a and 2b, the screw mechanism 10 primarily comprises a head 101, a threaded shank 102 and a tail 103. External threads 102′ are formed on the shank 102, wherein the diameter of the head 101 is greater than the outer diameter of the threaded shank 102 and the tail 103. As shown in FIG. 2b, the head 101, the shank 102 and the tail 103 are integrally formed, wherein the threaded shank 102 is disposed between the head 101 and the tail 103. In this embodiment, the tail 103 comprises a flexible clasp 1031, defining a longitudinal recess 1030 substantially parallel to the central axis C of the screw mechanism 10. Particularly, the clasp 1031 is flexible in the direction substantially perpendicular to the central axis C. The screw mechanism 10 is joined with an object P by inserting it through the screw hole P0 from the tail 103 along the first direction A1 parallel to the central axis C as shown in FIG. 2c.

As the flexible clasp 1031 of the tail 103 is restrained and compressed when passing through the screw hole P0, it is deformed from a first position 1031′ to a second position 1031″ in the direction perpendicular to the central axis C as shown in FIG. 2c. Thus, the following threaded shank 102 can smoothly progress upward through the screw hole P0. When the tail 103 crosses the object P, the clasp 1031 is released and spontaneously returns to the first position 1031′ from the second position 1031″ due to the flexibility thereof.

As mentioned, in FIG. 2c, the flexible clasp 1031 returns to the first position 1031′ when the screw mechanism 10 passes through the object P. Since the width of the flexible clasp 1031 in the first position 1031′ is greater than in the second position 1031″, it latches and abuts the surface of the object P when the screw mechanism 10 is removed from the object P along the second direction A2 opposite to the first direction A1. Thus, the screw mechanism 10 and the object P can be permanently joined without separation.

In summary, the invention provides a screw mechanism comprising a flexible clasp at the tail, preventing unexpected separation capable of easy insertion. Thus, the screw mechanism of the invention is widely applicable to screw components or rotatable knob mechanisms.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A screw mechanism for joining an object, extended along a central axis, comprising:
a head;
a tail, comprising a flexible clasp deformed from a first position to a second position along, the direction substantially perpendicular to the central axis when the screw mechanism is seated in the object in a first direction; and
a threaded shank between the head and the tail, wherein the outer diameter of the threaded shank is smaller than the head,
wherein the flexible clasp abuts the object at the first position when the screw mechanism is removed from the object opposite to the first direction thereby preventing separation.

2. The screw mechanism as claimed in claim 1, wherein the first direction is parallel to the central axis.

3. The screw mechanism as claimed in claim 1, wherein the flexible clasp forms a longitudinal recess substantially parallel to the central axis.

4. The screw mechanism as claimed in claim 1, wherein the threaded shank, the head and the tail are integrally formed.

5. The screw mechanism as claimed in claim 1, wherein the width of the tail is greater than the inner diameter of the threaded shank when the flexible clasp is at the first position.

6. The screw mechanism as claimed in claim 1, wherein the width of the flexible clasp perpendicular to the central axis is smaller than the head diameter.
